(19) United States
(12) Patent Application Publication
(10) Pub. No.: US 2024/0059287 A1
(43) Pub. Date: Feb. 22, 2024

(54) VEHICLE TRAVELING CONTROL DEVICE, VEHICLE TRAVELING CONTROL METHOD, AND STORAGE MEDIUM

(71) Applicant: TOYOTA JIDOSHA KABUSHI KAISHA, Toyota-shi (JP)

(72) Inventor: Hideyuki Wakamiya, Mishima-shi (JP)

(73) Assignee: TOYOTA JIDOSHA KABUSHIKI KAISHA, Toyota-shi (JP)

(21) Appl. No.: 17/891,568

(22) Filed: Aug. 19, 2022

(30) Foreign Application Priority Data
Sep. 10, 2021 (JP) 2021-147778

(51) Int. Cl. B60W 30/16

(52) U.S. Cl. CPC B60W 30/16; B60W 2520/10; B60W 2554/4041; B60W 2554/802; B60W 2554/406; B60W 2720/10

(57) ABSTRACT

A vehicle traveling control device executes follow-up traveling control in which an own vehicle is made to travel following a preceding vehicle under a condition. The vehicle traveling control device includes an acquiring unit that acquires traffic congestion information relating to a traffic congestion nearby the own vehicle, and a control unit that continues the follow-up traveling control such that the speed of the own vehicle does not exceed the predetermined speed, when a presence of the traffic congestion is detected based on the traffic congestion information while the follow-up traveling control is being executed, and subsequently, when the speed of the own vehicle reaches a reference speed that is no greater than the predetermined speed and the inter-vehicle distance reaches a reference distance that is no greater than the predetermined distance, starts predetermined control to end the follow-up traveling control.

### CROSS-REFERENCE TO RELATED APPLICATION

This application claims priority to Japanese Patent Application No. 2021-147778 filed on Sep. 10, 2021, incorporated herein by reference in its entirety.

### BACKGROUND OF THE DISCLOSURE

### 1. Field of the Disclosure

The disclosure relates to a technical field of a vehicle traveling control device, a vehicle traveling control method, and a storage medium.

### 2. Description of Related Art

There is proposed, as this type of device, a device in which different follow-up traveling control modes (low-speed follow-up traveling control mode, high-speed follow-up traveling control mode) are set for each vehicle speed region and switches the follow-up traveling control mode according to the speed of the own vehicle, for example, and when traffic congestion information is detected, expands the vehicle speed region of one of a plurality of the follow-up traveling control modes to suppress frequent switching of the follow-up traveling control modes (see Japanese Unexamined Patent Application Publication No. 2006-111170 (JP 2006-111170 A)). Examples of other related technology include Japanese Patent No. 6580108 (JP 6580108 B) and Japanese Unexamined Patent Application Publication No. 2020-152288 (JP 2020-152288 A). JP 6580108 B discloses that when the automatic driving level of an automatic driving vehicle that travels following a vehicle traveling ahead under follow-up traveling control is Level 3, and the own vehicle is starting from a standstill, an inter-vehicle distance between the own vehicle and the vehicle traveling ahead is set to be greater than the inter-vehicle distance when the automatic driving level is Level 2. JP 2020-152288 A discloses that when an own vehicle enters a narrow road during execution of a Level 3 automatic driving mode, the driving mode is switched to a driving mode desired by a driver.

### SUMMARY OF THE DISCLOSURE

In some follow-up traveling control modes, the upper limit speed is stipulated by law (for example, the upper limit speed of the follow-up traveling control mode of automatic driving level 3 during traffic congestion is 60 km/h). In such a follow-up traveling control mode, the vehicle speed region cannot be changed as in the technology described in JP 2006-111170 A. Also, the own vehicle is made to follow the preceding vehicle in the follow-up traveling control mode, and accordingly, switching the follow-up traveling control only in accordance with speed as in the technology described in JP 2006-111170 A causes the vehicle to be readily influenced by change of the speed of the preceding vehicle.

It is an object of the disclosure to provide a vehicle traveling control device, a vehicle traveling control method, and a storage medium, that enable suppressing switching of follow-up traveling control modes.

A vehicle traveling control device according to an aspect of the disclosure executes follow-up traveling control in which an own vehicle is made to travel following a preceding vehicle under a condition that a speed of the own vehicle is no greater than a predetermined speed and an inter-vehicle distance between the own vehicle and the preceding vehicle is no greater than a predetermined distance. The vehicle traveling control device includes an acquiring unit that acquires traffic congestion information relating to a traffic congestion nearby the own vehicle, and a control unit that continues the follow-up traveling control such that the speed of the own vehicle does not exceed the predetermined speed, when a presence of the traffic congestion is detected based on the traffic congestion information while the follow-up traveling control is being executed, and subsequently, when the speed of the own vehicle reaches the a reference speed that is no greater than the predetermined speed and the inter-vehicle distance reaches a reference distance that is no greater than the predetermined distance, starts predetermined control to end the follow-up traveling control.

A vehicle traveling control method according to an aspect of the disclosure is a vehicle traveling control method of a vehicle traveling control device that executes follow-up traveling control in which an own vehicle is made to travel following a preceding vehicle under a condition that a speed of the own vehicle is no greater than a predetermined speed and an inter-vehicle distance between the own vehicle and the preceding vehicle is no greater than a predetermined distance. The vehicle traveling control method includes the vehicle traveling control device acquiring traffic congestion information relating to a traffic congestion nearby the own vehicle, first controlling in which the vehicle traveling control device continues the follow-up traveling control such that the speed of the own vehicle does not exceed the predetermined speed, when a presence of the traffic congestion is detected based on the traffic congestion information while the follow-up traveling control is being executed, and second controlling in which, when the speed of the own vehicle reaches a reference speed that is no greater than the predetermined speed and the inter-vehicle distance reaches a reference distance that is no greater than the predetermined distance following the first controlling, the vehicle traveling control device starts predetermined control to end the follow-up traveling control.

A storage medium according to an aspect of the disclosure stores instructions that are executable by one or more processors of a vehicle traveling control device that executes follow-up traveling control in which an own vehicle is made to travel following a preceding vehicle under a condition that a speed of the own vehicle is no greater than a predetermined speed and an inter-vehicle distance between the own vehicle and the preceding vehicle is no greater than a predetermined distance, the instructions causing the one or more processors to perform functions. The functions include acquiring traffic congestion information relating to a traffic congestion nearby the own vehicle, and controlling to continue the follow-up traveling control such that the speed of the own vehicle does not exceed the predetermined speed, when a presence of traffic congestion is detected based on the traffic congestion information while the follow-up traveling control is being executed, and subsequently, when the speed of the own vehicle reaches a reference speed that is no greater than the predetermined speed and the inter-vehicle distance reaches a reference distance that is no greater than the predetermined distance, to start predetermined control to end the follow-up traveling control.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a configuration of a vehicle according to an embodiment;

FIG. 2 is a diagram illustrating an example of traffic conditions;

FIG. 3 is a flowchart showing operations of an electronic control unit (ECU) according to the embodiment; and

FIG. 4 is a block diagram illustrating a configuration of a computer according to the embodiment.

### DETAILED DESCRIPTION OF EMBODIMENTS

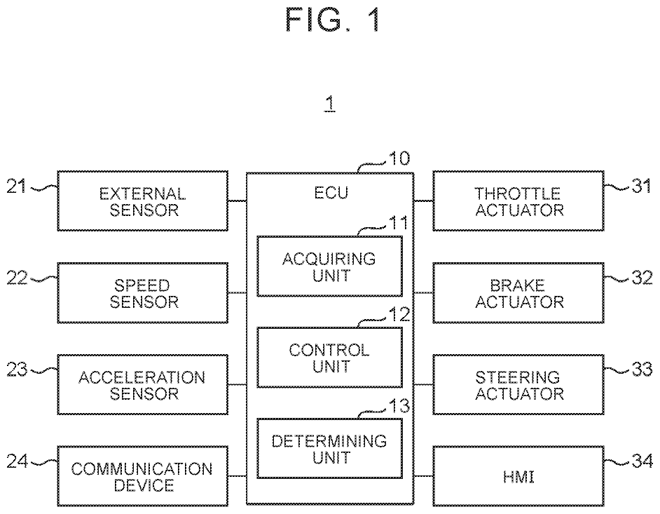

An embodiment of a vehicle traveling control device will be described with reference to FIGS. 1 to 3. An electronic control unit (ECU) 10 installed in a vehicle 1 will be described here as an example of the vehicle traveling control device. That is to say, in this embodiment, part of the ECU 10 for various types of control of the vehicle 1 is used as the vehicle traveling control device.

In FIG. 1, the vehicle 1 includes the ECU 10, an external sensor 21, a speed sensor 22, an acceleration sensor 23, a communication device 24, a throttle actuator 31, a brake actuator 32, a steering actuator 33, and a human-machine interface (HMI) 34. The vehicle 1 may be an autonomous driving vehicle. It should be noted that various types of existing sensors such as for example, a camera, a radar device, a LiDAR (an acronym of “Light Detection and Ranging”) device, and so forth, can be applied as the external sensor 21.

The ECU 10 is configured to be capable of executing automatic driving in which a driver is under duty of forward monitoring of the vehicle 1 (hereinafter, appropriately referred to as “first automatic driving”), and automatic driving in which the driver is exempt from duty of forward monitoring of the vehicle 1 (hereinafter, appropriately referred to as “second automatic driving”). The ECU 10 is capable of executing follow-up traveling control in which the vehicle 1 (i.e., the own vehicle) follows a preceding vehicle, for example, as the second automatic driving.

Here, follow-up traveling control as the second automatic driving is based on the premise that the vehicle 1 is traveling at a relatively low speed (no more than 60 km/h or the like), for example, in a congested section or the like. Accordingly, the follow-up traveling control as the second automatic driving can be executed when the speed of the vehicle 1 is no greater than an upper limit speed that is set in advance. Further, when the vehicle 1 is traveling at a relatively low speed, it is permissible for an inter-vehicle distance between the vehicle 1 and the preceding vehicle to be relatively small (several meters to several tens of meters, or the like). Accordingly, the follow-up traveling control as the second automatic driving can be executed when the inter-vehicle distance between the vehicle 1 and the preceding vehicle is no greater than an upper limit distance that is set in advance.

That is to say, the follow-up traveling control as the second automatic driving can be executed when the speed of the vehicle 1 is no greater than the upper limit speed, and the inter-vehicle distance between the vehicle 1 and the preceding vehicle is no greater than the upper limit distance. Accordingly, when the speed of the vehicle 1 exceeds the upper limit speed and/or when the inter-vehicle distance between the vehicle 1 and the preceding vehicle exceeds the upper limit distance, during execution of the follow-up traveling control as the second automatic driving, the follow-up traveling control is canceled.

When the follow-up traveling control as the second automatic driving is canceled, the automatic driving is switched from the second automatic driving to the first automatic driving. Here, when the follow-up traveling control as the second automatic driving is canceled due to the speed of the vehicle 1 exceeding the upper limit speed, the automatic driving may be switched from the second automatic driving to follow-up traveling control as the first automatic driving. Alternatively, when the follow-up traveling control as the second automatic driving is canceled due to the inter-vehicle distance between the vehicle 1 and the preceding vehicle exceeding the upper limit distance, the automatic driving may be switched from the second automatic driving to constant speed control as the first automatic driving. Note that the upper limit speed and the upper limit distance related to the follow-up traveling control as the first automatic driving are greater than the upper limit speed and the upper limit distance related to the follow-up traveling control as the second automatic driving.

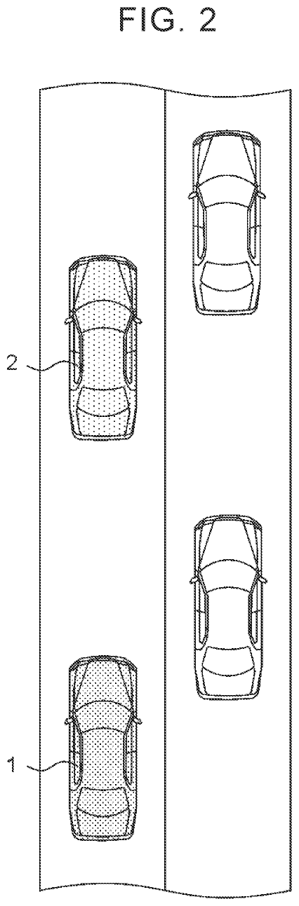

For example, a case will be considered in which the vehicle 1 travels following a vehicle 2 as the preceding vehicle by the follow-up traveling control as the second automatic driving in a congested section, as illustrated in FIG. 2. The traffic flow in the congested section is not uniform (i.e., vehicles in the congested section are not traveling at uniform low speed), and the traffic flow may become faster at certain portions, such as in a downhill section, for example.

When the vehicle 1 is traveling under follow-up traveling control as the second automatic driving, and the traffic flow temporarily becomes faster to the extent that the speed of the vehicle 1 exceeds the aforementioned upper limit speed, for example, causing the second automatic driving to switch to the first automatic driving, the driver is then under duty of forward monitoring of the vehicle 1. The speed of the vehicle 1 may then decrease immediately after switching from the second automatic driving to the first automatic driving, and the follow-up traveling control as the second automatic driving may be executable again. In such a case, the driver of the vehicle 1 may feel annoyed due to the switching from the second automatic driving to the first automatic driving.

Accordingly, the ECU 10 serving as the vehicle traveling control device controls the vehicle 1 so as to suppress cancellation of execution of the follow-up traveling control as the second automatic driving (e.g., so as to suppress switching of follow-up traveling control). The ECU 10 has an acquiring unit 11, a control unit 12, and a determining unit 13, as a logical block that is logically realized, or as a processing circuit that is physically realized, therein (see FIG. 1). In the following description, “follow-up traveling control as second automatic driving” will be referred to as “follow-up traveling control during traffic congestion”.

The acquiring unit 11 acquires detection (measurement) results of each of the external sensor 21, the speed sensor 22, and the acceleration sensor 23. The acquiring unit 11 acquires, for example, information related to the Vehicle Information and Communication System (VICS) (a registered trademark) information from other vehicles that are present in the vicinity of the vehicle 1, and so forth, via the communication device 24. The acquiring unit 11 acquires traffic congestion information related to traffic congestion nearby the vehicle 1 from the information acquired via the communication device 24.

For example, when the follow-up traveling control during traffic congestion is executed, the control unit 12 controls the throttle actuator 31, the brake actuator 32, and the steering actuator 33, such that the vehicle 1 travels along a travel route at a target speed, based on the respective detection results of the external sensor 21, the speed sensor 22, and the acceleration sensor 23, acquired by the acquiring unit 11.

The determining unit 13 determines whether follow-up traveling control during traffic congestion, for example, can be continued, based on the detection results of each of the external sensor 21, the speed sensor 22, and the acceleration sensor 23, acquired by the acquiring unit 11.

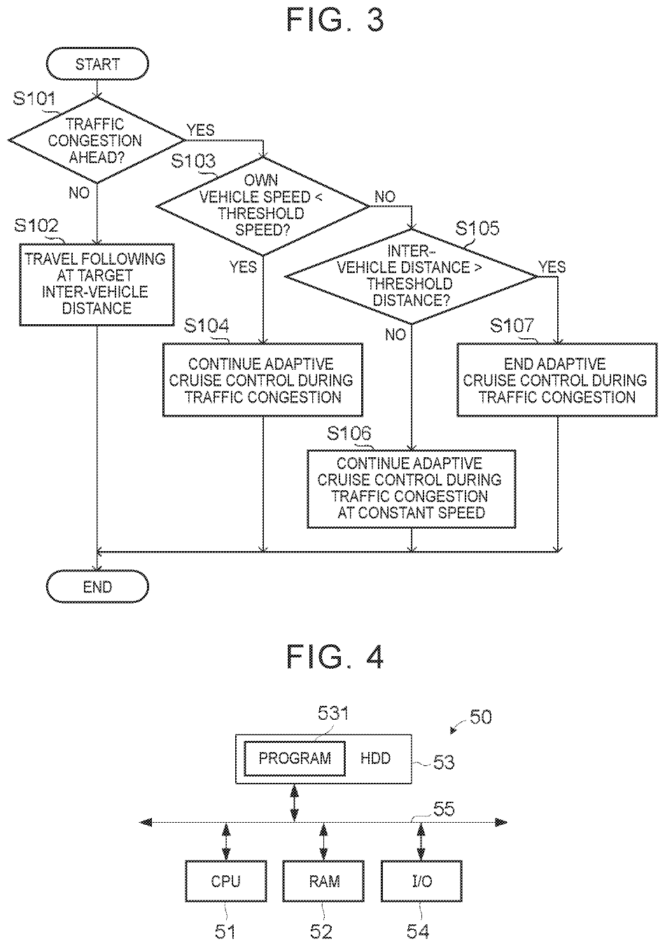

Next, operations of the ECU 10 will be described with reference to the flowchart in FIG. 3. Here, assumption will be made that the vehicle 1 is traveling in a congested section, for example, and the follow-up traveling control during traffic congestion for causing the vehicle 1 to follow the vehicle 2 (see FIG. 2) is being executed.

In FIG. 3, the determining unit 13 determines whether there is traffic congestion ahead of the vehicle 1, based on traffic congestion information acquired by the acquiring unit 11 (step S101). In the processing of this step S101, determination is made regarding whether the congested section through which the vehicle 1 is currently traveling will continue down the road, or the traffic congestion will let up, for example.

When determination is made in the processing of step S101 that there is no traffic congestion ahead of the vehicle 1 (No in step S101), the control unit 12 controls the throttle actuator 31 and so forth based on detection results from the external sensor 21 and so forth, acquired by the acquiring unit 11 so that the inter-vehicle distance between the vehicle 1 and the vehicle 2 is a target inter-vehicle distance, and the vehicle 1 is caused to travel following the vehicle 2 (step S102). Note that the target inter-vehicle distance may be changed in accordance with the speed of the vehicle 1.

In this case, the traffic congestion will let up, and accordingly the speed of the vehicle 1 will increase. The control unit 12 switches from the second automatic driving to the first automatic driving when the speed of the vehicle 1 exceeds the upper limit speed at which the follow-up traveling control during traffic congestion can be executed, for example. In this case, the control unit 12 may execute the first automatic driving to cause the vehicle 1 to follow the vehicle 2. The control unit 12 may alert the driver via the HMI 34 before switching from the second automatic driving to the first automatic driving.

When determination is made in the processing of step S101 that there is traffic congestion ahead of the vehicle 1 (Yes in step S101), the determining unit 13 determines whether the speed of the vehicle 1 (i.e., the speed of the own vehicle) is smaller than the threshold speed (step S103).

When determination is made in the processing of step S103 that the speed of the vehicle 1 is smaller than the threshold speed (Yes in step S103), the control unit 12 controls the throttle actuator 31 and so forth based on detection results from the external sensor 21 and so forth, acquired by the acquiring unit 11, so that the inter-vehicle distance between the vehicle 1 and the vehicle 2 maintains the target inter-vehicle distance, and continues follow-up traveling control during traffic congestion (step S104). Thereafter, following a predetermined amount of time having elapsed, the processing of step S101 may be performed. Note that in this case, when the speed of the vehicle 2 serving as the preceding vehicle increases, the control unit 12 may increase the speed of the vehicle 1 such that the upper limit speed related to the follow-up traveling control during traffic congestion is not exceeded.

When determination is made in the processing of step S103 that the speed of the vehicle 1 is no less than the threshold speed (No in step S103), the determining unit 13 determines whether the inter-vehicle distance between the vehicle 1 and the vehicle 2 is greater than a threshold distance (step S105).

When determination is made in the processing of step S105 that the inter-vehicle distance between the vehicle 1 and the vehicle 2 is no greater than the threshold distance (No in step S105), the control unit 12 maintains the speed of the vehicle 1 at a constant speed and continues follow-up traveling control during traffic congestion, while allowing the inter-vehicle distance between the vehicle 1 and the vehicle 2 to be greater than the target inter-vehicle distance (step S106). Thereafter, following a predetermined amount of time having elapsed, the processing of step S101 may be performed. Note that in this case, the control unit 12 may set the speed of the vehicle 1 to the upper limit speed related to the follow-up traveling control during traffic congestion.

When determination is made in the processing of step S105 that the inter-vehicle distance between the vehicle 1 and the vehicle 2 is greater than the threshold distance (Yes in step S105), the control unit 12 ends the follow-up traveling control during traffic congestion (in other words, execution of the follow-up traveling control during traffic congestion is cancelled) (step S107). At this time, the control unit 12 may alert the driver via the HMI 34. In the processing of step S107, the control unit 12 may switch from the second automatic driving to the first automatic driving, and execute the first automatic driving in which the vehicle 1 is caused to travel following the vehicle 2, for example.

The “threshold speed” is a value for deciding whether to perform the follow-up traveling control during traffic congestion during which the target inter-vehicle distance is maintained, and may be set in advance as a fixed value, or a variable value in accordance with some physical quantity or parameter. The “threshold speed” is a speed smaller than the upper limit speed at which the follow-up traveling control during traffic congestion can be executed. Such a threshold speed may be set as a speed that is smaller than the above upper limit speed by a predetermined value, for example, in accordance with the range of change of the speed of the vehicle 1 due to control error or disturbance. That is to say, the threshold speed may be set as a speed at which execution of follow-up traveling control during traffic congestion is not canceled due to an unintended speed change of the vehicle 1.

The “threshold distance” is a value for determining whether to end the follow-up traveling control during traffic congestion, and may be set in advance as a fixed value, or a variable value in accordance with some physical quantity or parameter. The “threshold distance” is a distance smaller than the upper limit distance at which the follow-up traveling control during traffic congestion can be executed. Such a threshold distance may be set in accordance with the state of the driver. That is to say, in the second automatic driving, the driver is not under duty of forward monitoring of the vehicle 1. Accordingly, when the follow-up traveling control during traffic congestion is being executed, the driver may be inattentive to the road so as to speak, such as intently viewing an electronic device unrelated to driving operations, for example. Thus, the threshold distance may be set to a distance such that the inter-vehicle distance will not exceed the upper limit distance at which follow-up traveling control during traffic congestion can be executed before the driver returns to driving operations, based on the amount of time required for the driver to return to driving operations, and the inter-vehicle distance between the vehicle 1 and the vehicle 2 (i.e., the preceding vehicle) changing during this amount of time, for example.

Technical Advantages

The ECU 10 serving as the vehicle traveling control device continues the follow-up traveling control during traffic congestion so that the speed of the vehicle 1 does not exceed the threshold speed when the presence of traffic congestion is detected while the follow-up traveling control during traffic congestion is being executed. Thereafter, when the speed of the vehicle 1 reaches the threshold speed, the ECU 10 continues the follow-up traveling control during traffic congestion so that the inter-vehicle distance between the vehicle 1 and the vehicle 2 that is the preceding vehicle does not exceed the threshold distance, while maintaining the speed of the vehicle 1.

Thus, the speed of the vehicle 1 is suppressed from exceeding the upper limit speed at which the follow-up traveling control during traffic congestion can be executed, and the inter-vehicle distance between the vehicle 1 and the vehicle 2 can be suppressed from exceeding the upper limit distance at which the follow-up traveling control during traffic congestion can be executed.

According to such a configuration, even when the speed of the vehicle 2 that is the preceding vehicle temporarily increases in a congested section, cancellation of execution of the follow-up traveling control during traffic congestion can be suppressed. That is to say, switching from the second automatic driving to the first automatic driving can be suppressed. Therefore, according to the ECU 10, switching between the follow-up traveling control as the second automatic driving and the follow-up traveling control as the first automatic driving can be suppressed.

After switching from the second automatic driving to the first automatic driving, the speed of the vehicle 1 may decrease, and the second automatic driving (follow-up traveling control during traffic congestion here) may become executable. When switching between the first automatic driving and the second automatic driving occurs relatively frequently, the driver of the vehicle 1 may find this annoying. Conversely, according to the ECU 10, execution of the follow-up traveling control during traffic congestion can be suppressed from being canceled, and thus the driver can be kept from feeling annoyed.

Computer Program

An embodiment relating to a computer program will be described with reference to FIG. 4. FIG. 4 is a block diagram illustrating a configuration of a computer according to the embodiment.

In FIG. 4, the computer 50 makes up the vehicle traveling control device (e.g., the ECU 10 described above). The computer 50 includes a central processing unit (CPU) 51, random-access memory (RAM) 52, a hard disk drive (HDD) 53, and an input/output (I/O) 54. The CPU 51, the RAM 52, the HDD 53, and the I/O 54 are connected to each other by a bus 55. A computer program 531 according to the present embodiment is stored in the HDD 53 in advance. The CPU 51 may be made up of one or a plurality of processors.

Processing of the CPU 51 by the computer program 531 will be described. The CPU 51 determines whether there is traffic congestion ahead of the own vehicle, based on traffic congestion information acquired via the I/O 54. When determination is made that there is no traffic congestion ahead of the own vehicle, the CPU 51 controls the throttle actuator 31 and so forth based on detection results from the external sensor 21 and so forth, acquired via the I/O 54 so that the inter-vehicle distance between the own vehicle and the preceding vehicle is the target inter-vehicle distance, thereby causing the own vehicle to travel following the preceding vehicle. In this case, the automatic driving is switched from the second automatic driving to the first automatic driving when the speed of the own vehicle exceeds the upper limit speed at which the follow-up traveling control during traffic congestion can be executed.

When determination is made that there is traffic congestion ahead of the own vehicle, the CPU 51 determines whether the speed of the own vehicle is smaller than the threshold speed. When determination is made that the speed of the own vehicle is smaller than the threshold speed, the CPU 51 continues the follow-up traveling control during traffic congestion so that the inter-vehicle distance between the own vehicle and the preceding vehicle is maintained at the target inter-vehicle distance.

When determination is made that the speed of the own vehicle is no smaller than the threshold speed, the CPU 51 determines whether the inter-vehicle distance between the own vehicle and the preceding vehicle is greater than the threshold distance. When determination is made that the inter-vehicle distance between the own vehicle and the preceding vehicle is no greater than the threshold distance, the CPU 51 continues the follow-up traveling control during traffic congestion maintaining the speed of the own vehicle constant, while allowing the inter-vehicle distance to be greater than the target inter-vehicle distance. Conversely, when determination is made that the inter-vehicle distance between the own vehicle and the preceding vehicle is greater than the threshold distance, the CPU 51 ends the follow-up traveling control during traffic congestion.

Note that the computer program 531 may be stored in the HDD 53 by the computer 50 reading the computer program 531 from a recording medium like an optical disk such as compact disc read-only memory (CD-ROM) or the like, or Universal Serial Bus (USB) memory or the like, that stores the computer program 531, for example. The recording media described above are examples of a storage medium. Alternatively, the computer program 531 may be stored in the HDD 53 by the computer 50 downloading the computer program 531 over a network such as the Internet, for example.

According to the computer program 531, switching between follow-up traveling control as second automatic driving and follow-up traveling control as first automatic driving can be suppressed, in the same way as with the ECU 10 serving as the vehicle traveling control device in the above-described embodiment. According to the computer program 531, the ECU 10 serving as the vehicle traveling control device in the above-described embodiment can be realized relatively easily.

Various aspects of the disclosure derived from the embodiments described above will be described below.

A vehicle traveling control device according to an aspect of the disclosure executes follow-up traveling control in which an own vehicle is made to travel following a preceding vehicle under a condition that a speed of the own vehicle is no greater than a predetermined speed and an inter-vehicle distance between the own vehicle and the preceding vehicle is no greater than a predetermined distance. The vehicle traveling control device includes an acquiring unit that acquires traffic congestion information relating to a traffic congestion nearby the own vehicle, and a control unit that continues the follow-up traveling control such that the speed of the own vehicle does not exceed the predetermined speed, when a presence of the traffic congestion is detected based on the traffic congestion information while the follow-up traveling control is being executed, and subsequently, when the speed of the own vehicle reaches a reference speed that is no greater than the predetermined speed and the inter-vehicle distance reaches a reference distance that is no greater than the predetermined distance, starts predetermined control to end the follow-up traveling control.

In the above-described embodiment, the “ECU 10” corresponds to an example of “vehicle traveling control device”, the “acquiring unit 11” corresponds to an example of “acquiring unit”, the “control unit 12” corresponds to an example of “control unit”, the “follow-up traveling control during traffic congestion” corresponds to an example of “follow-up traveling control”, the “threshold speed” corresponds to an example of “reference speed”, and the “threshold distance” corresponds to an example of “reference distance”. In the above-described embodiment, the “alert the driver via the HMI 34” corresponds to an example of “predetermined control to end the follow-up traveling control”.

In the vehicle traveling control device, when the presence of the traffic congestion is detected based on the traffic congestion information while the follow-up traveling control is being executed, and the speed of the own vehicle reaches the reference speed, the control unit may continue the follow-up traveling control such that the inter-vehicle distance does not exceed the reference distance, while maintaining the speed of the own vehicle.

A vehicle traveling control method according to an aspect of the disclosure is a vehicle traveling control method of a vehicle traveling control device that executes follow-up traveling control in which an own vehicle is made to travel following a preceding vehicle under a condition that a speed of the own vehicle is no greater than a predetermined speed and an inter-vehicle distance between the own vehicle and the preceding vehicle is no greater than a predetermined distance. The vehicle traveling control method includes the vehicle traveling control device acquiring traffic congestion information relating to a traffic congestion nearby the own vehicle, first controlling in which the vehicle traveling control device continues the follow-up traveling control such that the speed of the own vehicle does not exceed the predetermined speed, when a presence of the traffic congestion is detected based on the traffic congestion information while the follow-up traveling control is being executed, and second controlling in which, when the speed of the own vehicle reaches a reference speed that is no greater than the predetermined speed and the inter-vehicle distance reaches a reference distance that is no greater than the predetermined distance following the first controlling, the vehicle traveling control device starts predetermined control to end the follow-up traveling control.

A storage medium according to an aspect of the disclosure is a non-transitory storage medium that stores instructions that are executable by one or more processors of a vehicle traveling control device that executes follow-up traveling control in which an own vehicle is made to travel following a preceding vehicle under a condition that a speed of the own vehicle is no greater than a predetermined speed and an inter-vehicle distance between the own vehicle and the preceding vehicle is no greater than a predetermined distance, the instructions causing the one or more processors to perform functions. The functions include acquiring traffic congestion information relating to a traffic congestion nearby the own vehicle, and controlling to continue the follow-up traveling control such that the speed of the own vehicle does not exceed a reference speed that is no greater than the predetermined speed, when a presence of the traffic congestion is detected based on the traffic congestion information while the follow-up traveling control is being executed, and subsequently, when the speed of the own vehicle reaches the reference speed and the inter-vehicle distance reaches a reference distance that is no greater than the predetermined distance, to start predetermined control to end the follow-up traveling control.

The disclosure is not limited to the above-described embodiment, and can be appropriately modified without departing from the essence or spirit of the disclosure that can be read from the claims and the entire specification, and a vehicle traveling control device, a vehicle traveling control method, and a storage medium, with such modifications, are also within the technical scope of the disclosure.

What is claimed is:

1. A vehicle traveling control device that executes follow-up traveling control in which an own vehicle is made to travel following a preceding vehicle under a condition that a speed of the own vehicle is no greater than a predetermined speed and an inter-vehicle distance between the own vehicle and the preceding vehicle is no greater than a predetermined distance, the vehicle traveling control device comprising:
an acquiring unit that acquires traffic congestion information relating to a traffic congestion nearby the own vehicle; and
a control unit that continues the follow-up traveling control such that the speed of the own vehicle does not exceed the predetermined speed, when a presence of the traffic congestion is detected based on the traffic congestion information while the follow-up traveling control is being executed, and subsequently, when the speed of the own vehicle reaches a reference speed that is no greater than the predetermined speed and the inter-vehicle distance reaches a reference distance that is no greater than the predetermined distance, starts predetermined control to end the follow-up traveling control.

2. The vehicle traveling control device according to claim 1, wherein, when the presence of the traffic congestion is detected based on the traffic congestion information while the follow-up traveling control is being executed, and the speed of the own vehicle reaches the reference speed, the control unit continues the follow-up traveling control such that the inter-vehicle distance does not exceed the reference distance, while maintaining the speed of the own vehicle.

3. A vehicle traveling control method of a vehicle traveling control device that executes follow-up traveling control in which an own vehicle is made to travel following a preceding vehicle under a condition that a speed of the own vehicle is no greater than a predetermined speed and an inter-vehicle distance between the own vehicle and the preceding vehicle is no greater than a predetermined distance, the vehicle traveling control method comprising:
the vehicle traveling control device acquiring traffic congestion information relating to a traffic congestion nearby the own vehicle;
first controlling in which the vehicle traveling control device continues the follow-up traveling control such that the speed of the own vehicle does not exceed the predetermined speed, when a presence of the traffic congestion is detected based on the traffic congestion information while the follow-up traveling control is being executed; and
second controlling in which, when the speed of the own vehicle reaches a reference speed that is no greater than the predetermined speed and the inter-vehicle distance reaches a reference distance that is no greater than the predetermined distance following the first controlling, the vehicle traveling control device starts predetermined control to end the follow-up traveling control.

4. A non-transitory storage medium storing instructions that are executable by one or more processors of a vehicle traveling control device that executes follow-up traveling control in which an own vehicle is made to travel following a preceding vehicle under a condition that a speed of the own vehicle is no greater than a predetermined speed and an inter-vehicle distance between the own vehicle and the preceding vehicle is no greater than a predetermined distance, the instructions causing the one or more processors to perform functions comprising:
acquiring traffic congestion information relating to a traffic congestion nearby the own vehicle; and
controlling to continue the follow-up traveling control such that the speed of the own vehicle does not exceed the predetermined speed, when a presence of the traffic congestion is detected based on the traffic congestion information while the follow-up traveling control is being executed, and subsequently, when the speed of the own vehicle reaches a reference speed that is no greater than the predetermined speed and the inter-vehicle distance reaches a reference distance that is no greater than the predetermined distance, to start predetermined control to end the follow-up traveling control.
